(19) United States
(12) Patent Application Publication
(10) Pub. No.: US 2025/0183351 A1
(43) Pub. Date: Jun. 5, 2025

(54) POWER STORAGE MODULE AND METHOD OF MANUFACTURING THE SAME

(71) Applicant: TOYOTA JIDOSHA KABUSHIKI KAISHA, Toyota-shi (JP)

(72) Inventor: Shuichi NISHIDA, Toyota-shi (JP)

(73) Assignee: TOYOTA JIDOSHA KABUSHIKI KAISHA, Toyota-shi (JP)

(21) Appl. No.: 18/956,026

(22) Filed: Nov. 22, 2024

(30) Foreign Application Priority Data
Dec. 4, 2023 (JP) 2023-204528

(51) Int. Cl. H01M 10/04; H01M 50/103

(52) U.S. Cl. CPC H01M 10/0486; H01M 10/049; H01M 50/103

(57) ABSTRACT

The power storage module includes an electrode body including a plurality of electrodes stacked on each other, and a frame body having a shape surrounding the periphery of the electrode body and holding an edge portion of the electrode body. The frame body has a pair of outer holding portions that hold the outer end portions in the stacking direction among the edge portions of the electrode body, and an intermediate holding portion that is provided between the pair of outer holding portions in the stacking direction and holds a portion other than the portion held by the pair of outer holding portions among the edge portions of the electrode body. The length of the outer holding portion in the orthogonal direction orthogonal to the stacking direction is larger than the length of the intermediate holding portion in the orthogonal direction.

### CROSS-REFERENCE TO RELATED APPLICATION

This application claims priority to Japanese Patent Application No. 2023-204528 filed on Dec. 4, 2023, incorporated herein by reference in its entirety.

### BACKGROUND

### 1. Technical Field

The present disclosure relates to a power storage module and a method of manufacturing the same.

### 2. Description of Related Art

Japanese Unexamined Patent Application Publication No. 2021-15679 (JP 2021-15679 A) discloses a power storage module including a plurality of power storage cells stacked on each other, a cell storage body, and an elastic member disposed in the cell storage body.

### SUMMARY

In a power storage module such as that described in JP 2021-15679 A, warpage may occur in the power storage module due to an external temperature change, an external force, or the like when the power storage module is mounted on a vehicle.

An object of the present disclosure is to provide a power storage module capable of suppressing occurrence of warpage and a method of manufacturing the same.

An aspect of the present disclosure provides a power storage module including:

an electrode body including a plurality of electrodes stacked on each other; and
a frame body that has a shape surrounding a periphery of the electrode body and that holds an edge portion of the electrode body, in which:
the frame body includes
a pair of outer holding portions that holds outer end portions of the edge portion of the electrode body in a stacking direction of the electrode body, and
an intermediate holding portion that is provided between the outer holding portions in the stacking direction and that holds a portion of the edge portion of the electrode body other than the portions held by the outer holding portions; and
a length of the outer holding portions in an orthogonal direction orthogonal to the stacking direction is greater than a length of the intermediate holding portion in the orthogonal direction.

In addition, an aspect of the present disclosure provides

a method of manufacturing a power storage module including an electrode body including a plurality of electrodes stacked on each other, and a frame body that has a shape surrounding a periphery of the electrode body and that holds an edge portion of the electrode body, the method including:
stacking the electrodes and holding elements that hold edge portions of the electrodes via a separator; and
forming the frame body by melting the holding elements and integrating the holding elements, wherein
in the stacking, the electrodes and the holding elements are stacked via the separator such that outer surfaces of the holding elements disposed on an outer side in a stacking direction of the electrode body are positioned on an outer side in a direction orthogonal to the stacking direction with respect to an outer surface of the holding element disposed at a center in the stacking direction.

According to the present disclosure, it is possible to provide a power storage module capable of suppressing occurrence of warpage and a method of manufacturing the same.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a power storage module according to an embodiment of the present disclosure;

FIG. 2 is a cross-sectional view of II-II shown in FIG. 1;

FIG. 3 is a cross-sectional view schematically showing a stacking step in a method of manufacturing a power storage module;

FIG. 4 is a cross-sectional view schematically showing a frame body forming step in the method of manufacturing the power storage module;

FIG. 5 is a cross-sectional view schematically illustrating a modification of the method of manufacturing the power storage module;

FIG. 6 is a cross-sectional view schematically illustrating a modification of the method of manufacturing the power storage module;

FIG. 7 is a cross-sectional view schematically showing a modification of the manufacturing process of the power storage module; and

FIG. 8 is a cross-sectional view schematically showing a modification of the method of manufacturing the power storage module.

### DETAILED DESCRIPTION OF EMBODIMENTS

Embodiments of the present disclosure will be described with reference to the drawings. In the drawings referred to below, the same or corresponding members are denoted by the same reference numerals.

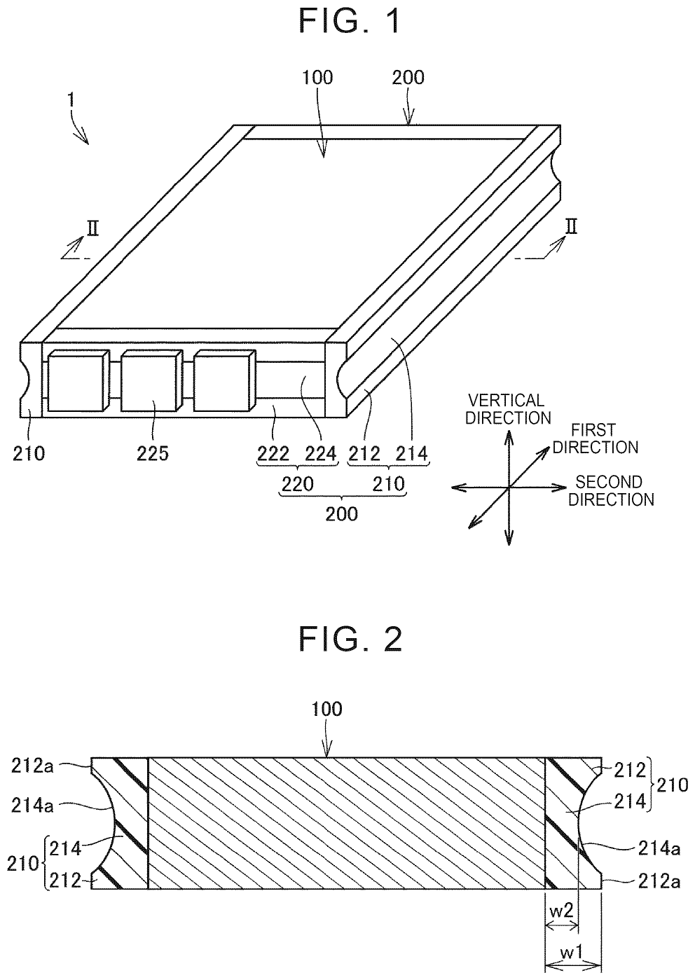

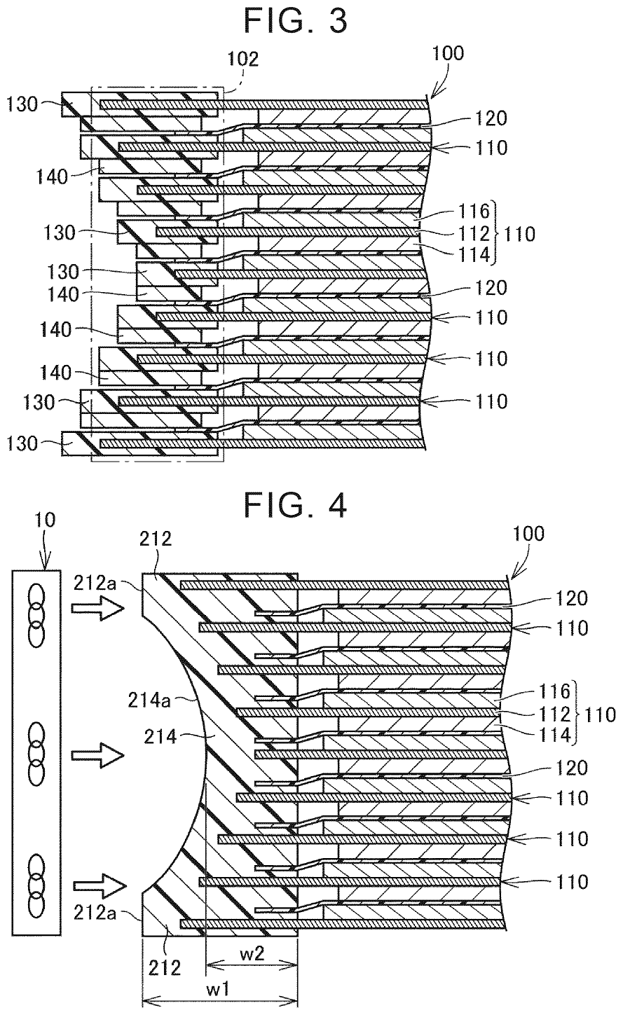

FIG. 1 is a perspective view schematically illustrating a power storage module according to an embodiment of the present disclosure. FIG. 2 is a cross-sectional view taken along II-II line shown in FIG. 1. FIG. 3 is a cross-sectional view schematically showing a stacking step in the method of manufacturing the power storage module. FIG. 4 is a cross-sectional view schematically showing a frame body forming step in the method of manufacturing the power storage module.

As illustrated in FIGS. 1 and 2, the power storage module 1 includes an electrode body 100 and a frame body 200. Although not shown, a plurality of power storage modules 1 are stacked to form a power storage device.

The electrode body 100 includes a plurality of electrodes 110 and a plurality of separators 120.

The plurality of electrodes 110 are stacked on each other. In the present embodiment, as shown in FIG. 3, each electrode 110 is composed of a bipolar electrode. Each electrode 110 includes a current collector foil 112, a positive electrode active material layer 114 provided on one surface of the current collector foil 112, and a negative electrode active material layer 116 provided on the other surface of the current collector foil 112. Each of the electrodes may be formed of a monopolar electrode (not shown).

The separator 120 is disposed between a pair of electrodes 110 adjacent to each other in the stacking direction (vertical direction in FIG. 3) of the plurality of electrodes 110. Specifically, each separator 120 is disposed between the positive electrode active material layer 114 and the negative electrode active material layer 116. Each separator 120 is made of an insulating material and allows transmission of ions. Examples of the separators 120 include polyolefin microporous membranes.

As shown in FIG. 3, the electrode body 100 has an edge portion 102. The edge portion 102 includes a peripheral edge portion of the current collector foil 112 and a peripheral edge portion of the separator 120.

The frame body 200 has a shape surrounding the periphery of the electrode body 100. The frame body 200 holds an edge portion 102 (see FIG. 3) of the electrode body 100. The frame body 200 is made of an insulating material. The frame body 200 is preferably made of a thermoplastic resin (polyethylene, polypropylene, or the like). The frame body 200 seals the edge portion 102 of the electrode body 100. The frame body 200 has a function of suppressing leakage of the electrolyte from the electrode body 100 and intrusion of moisture from the outside into the electrode body 100, and a function of securing an interval between the electrodes. The frame body 200 is formed in a rectangular cylindrical shape.

The frame body 200 includes a pair of first frame portions 210 and a pair of second frame portions 220.

The pair of first frame portions 210 face each other. The pair of first frame portions 210 holds a part of the edge portion 102 of the electrode body 100. Each of the first frame portions 210 has a shape extending in the first direction (see FIG. 1).

The shape of the first frame portion 210 is set so that the cross-sectional secondary moment increases. The first frame portion 210 includes a pair of outer holding portions 212 and an intermediate holding portion 214.

Each of the outer holding portions 212 holds an outer end portion of the edge portion 102 of the electrode body 100 in the stacking direction.

The intermediate holding portion 214 is provided between the pair of outer holding portions 212 in the stacking direction. The intermediate holding portion 214 holds a portion of the edge portion 102 of the electrode body 100 other than the portion held by the pair of outer holding portions 212. The intermediate holding portion 214 holds a central portion of the edge portion 102 of the electrode body 100 in the stacking direction.

As illustrated in FIGS. 1, 2, and 4, the length w1 of the outer holding portions 212 in the orthogonal direction (the left-right direction in FIG. 2) orthogonal to the stacking direction is larger than the length w2 of the intermediate holding portion 214 in the orthogonal direction. For the length w1 and the length w2, see FIGS. 2 and 4. In the present embodiment, the outer surface 212a of the outer holding portions 212 are positioned perpendicularly to the outer side of the outer surface 214a of the intermediate holding portion 214. As shown in FIGS. 1 and 2, the outer surface 214a of the intermediate holding portion 214 may be curved so as to be convex toward the center of the electrode body 100.

As shown in FIGS. 3 and 4, the length of the portion of the edge portion 102 of the electrode body 100 held by the intermediate holding portion 214 in the orthogonal direction is smaller than the length of the portion of the edge portion 102 of the electrode body 100 held by the outer holding portion 212 in the orthogonal direction.

Each of the pair of second frame portions 220 extends in a direction intersecting with the first frame portion 210 and faces each other. In the present embodiment, each second frame portion 220 extends in a second direction (see FIG. 1) orthogonal to the first frame portion 210. The length of the second frame portion 220 in the second direction is smaller than the length of the first frame portion 210 in the first direction. The pair of second frame portions 220 holds the remainder of the edge portion 102 of the electrode body 25 100.

In the present embodiment, each of the second frame portions 220 has the same shape as the first frame portion 210. That is, as shown in FIG. 1, the second frame portion 220 includes a pair of outer holding portions 222 and an intermediate holding portion 224. However, each of the second frame portions 220 may be formed in a flat plate shape, and the outer holding portion 222 and the intermediate holding portion 224 may be omitted. In other words, the pair of outer holding portions and the intermediate holding portions may be formed only in the first frame portions 210 that constitute the long side portions of the frame body 200 formed in the square cylindrical shape.

A plurality of liquid injection ports 225 (see FIG. 1) for supplying an electrolytic solution to the electrode body 100 may be formed in one of the pair of second frame portions 220. The plurality of liquid injection ports 225 are provided at intervals along the second direction. Although three liquid injection ports 225 are shown in FIG. 1 for convenience, the number of liquid injection ports 225 is not limited to three.

A voltage detection terminal (not shown) may be provided on one of the pair of second frame portions 220. The voltage detection terminal is electrically connected to the electrode 110 of the electrode body 100. The voltage detection terminal may be provided at an end portion of the second frame portion 220 in the second direction.

Next, a method of manufacturing the power storage module 1 will be described with reference to FIGS. 3 and 4. This manufacturing method includes a lamination step and a frame body forming step.

In the lamination step, the electrode 110 and the holding element 130 holding the edge of the electrode 110 are laminated via the separator 120 and the intervening member 140.

Each retaining element 130 retains the periphery of the electrode 110. More specifically, each holding element 130 holds the periphery of the current collector foil 112. Each holding element 130 is made of the same material as the material forming the frame body 200.

As shown in FIG. 3, the length of each holding element 130 gradually increases in the orthogonal direction toward the outside in the stacking direction. The holding length of the current collector foil 112 by each holding element 130 gradually decreases from the outside toward the center in the stacking direction. In this way, when each holding element 130 is heated in the frame body forming step, the thermal influence on the current collector foil 112 disposed in the central portion in the stacking direction is reduced.

Each intervening member 140 is disposed between a pair of holding elements 130 adjacent to each other in the stacking direction. Each intervening member 140 is made of the same material as the material forming the frame body 200. The intervening member 140 has a function of adjusting a dimension between the pair of holding elements 130 adjacent to each other in the stacking direction. Incidentally, by adjusting the thickness of each holding element 130 in the stacking direction, the intervening member 140 may be omitted.

As shown in FIG. 3, in the lamination process, the electrode 110 and the holding element 130 are laminated via the separator 120 and the intervening member 140. As a result, the outer surface of the holding element 130 disposed on the outer side in the stacking direction is located on the outer side in the orthogonal direction (the left-right direction in FIG. 3) with respect to the outer surface of the holding element 130 disposed at the center in the stacking direction.

In the frame body forming step, the frame body 200 is formed by melting the holding elements 130 and the intervening members 140 and integrating them. As shown in FIG. 4, in the frame body forming step, the holding elements 130 and the intervening members 140 are melted by applying heat to the holding elements 130 and the intervening members 140 from the side in the orthogonal direction. In this step, a heater 10, for example, is used as a means for applying heat to each holding element 130 and each intervening member 140.

As described above, in the power storage module 1 according to the present embodiment, the length w1 of the outer holding portion 212 in the orthogonal direction is larger than the length w2 of the intermediate holding portion 214 in the orthogonal direction. Therefore, the cross-sectional secondary moment of the first frame portions 210 is larger than when the length w1 is the same as the length w2. The same applies to each of the second frame portions 220. Therefore, the occurrence of warpage in the power storage module 1 is suppressed.

Hereinafter, a modification example of the above-described embodiment will be described.

### First Modification

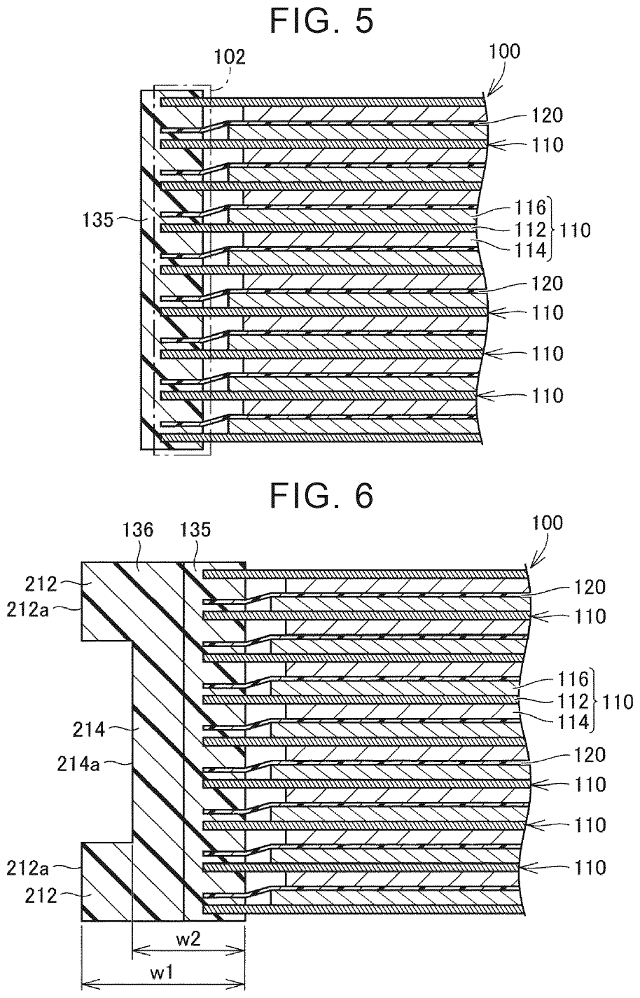

In the method of manufacturing the power storage module 1 according to the first modification, first, as shown in FIG. 5, the primary seal portion 135 is formed by heating each holding element 130 and each intervening member 140 with a heater. The primary seal portion 135 is formed in a substantially flat plate shape. That is, the outer surface of the primary seal portion 135 is formed flat.

Next, as shown in FIG. 6, the reinforcing portion 136 is connected to the outer surface of the primary seal portion 135 by injection molding or the like. The reinforcing portion 136 includes a pair of outer holding portions 212 and an intermediate holding portion 214. As shown in FIG. 6, the outer surface 214s of the intermediate holding portion 214 may be formed substantially parallel to the outer surface 212s of the outer holding portion 212.

### Second Modification

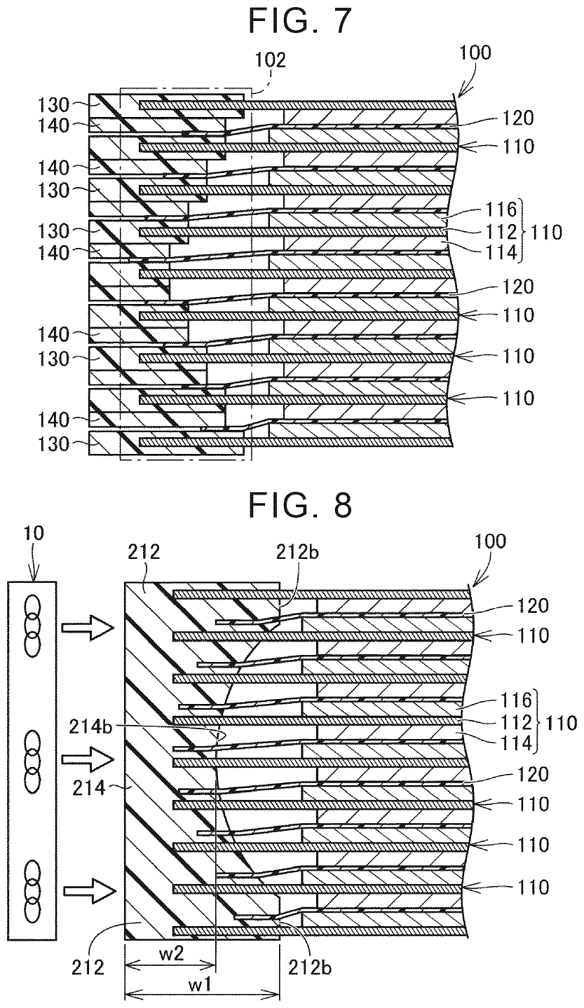

In the method of manufacturing the power storage module 1 according to the second modification, as shown in FIG. 7, in the lamination step, the electrode 110 and the holding element 130 are laminated via the separator 120 and the intervening member 140. As a result, the inner surface of the holding element 130 disposed on the outer side in the stacking direction is located on the inner side in the orthogonal direction than the inner surface of the holding element 130 disposed at the center in the stacking direction. Note that the outer surface of each holding element 130 and the outer surface of each intervening member 140 may be substantially flush with each other.

In the example shown in FIG. 7, the holding length of the current collector foil 112 by each holding element 130 gradually increases from the center portion toward the outside in the stacking direction. However, the holding length of the current collector foil 112 by each holding element 130 may be set to be uniform.

In this embodiment, the inner surface 212b of the outer holding portions 212 are positioned perpendicularly inward of the inner surface 214b of the intermediate holding portion 214. As illustrated in FIG. 8, the inner surface 214b of the intermediate holding portion 214 may be curved so as to be convex in a direction away from the center of the electrode body 100.

It will be understood by those skilled in the art that the exemplary embodiments and examples described above are illustrative of the following aspects.

### First Aspect

An electrode body including a plurality of electrodes laminated to each other,

A frame body having a shape surrounding the periphery of the electrode body for holding the edge of the electrode body,
The frame body includes
a pair of outer holding portions for holding the outer end portion in the stacking direction of the electrode body of the edge portion of the electrode body,
It is provided between the pair of outer holding portions in the stacking direction, and has an intermediate holding portion for holding a portion other than the portion held by the pair of outer holding portion of the edge portion of the electrode body,
A power storage module, wherein a length of the outer holding portion in an orthogonal direction orthogonal to the stacking direction is larger than a length of the intermediate holding portion in the orthogonal direction.

In this power storage module, the length of the outer holding portion in the orthogonal direction is larger than the length of the intermediate holding portion in the orthogonal direction. Therefore, the cross-sectional secondary moment of the frame body is larger than in the case where the length of each outer holding portion in the orthogonal direction is the same as the length of the intermediate holding portion in the orthogonal direction. Therefore, occurrence of warpage in the power storage module is suppressed.

### Second Aspect

The power storage module according to aspect 1, wherein an outer surface of each of the pair of outer holding portions is located outside the outer surface of the intermediate holding portion in a direction orthogonal to the stacking direction.

### Third Aspect

The power storage module according to aspect 2, wherein the outer surface of the intermediate holding portion has a shape curved so as to be convex toward the electrode body.

### Fourth Aspect

The power storage module according to any one of aspects 1 to 3, wherein a length of a portion of the edge portion of the electrode body held by the intermediate holding portion in the orthogonal direction is smaller than a length of a portion of the edge portion of the electrode body held by the outer holding portion in the orthogonal direction.

### Fifth Aspect

A method of manufacturing a power storage module, including: an electrode body including a plurality of electrodes stacked on each other; and a frame body having a shape surrounding the periphery of the electrode body and holding an edge portion of the electrode body.

A laminating step of laminating the electrode and the holding element for holding the edge of the electrode via a separator,
A frame body forming step of forming the frame body by melting the holding element and integrating them,
In the stacking step, the outer surface of the holding element disposed on the outer side in the stacking direction of the electrode body is positioned on the outer side in the direction orthogonal to the stacking direction than the outer surface of the holding element disposed in the center in the stacking direction, the electrode and the holding element via the separator, a method of manufacturing a power storage module.

### Sixth Aspect

The method for manufacturing a power storage module according to aspect 5, wherein in the frame body forming step, each of the holding elements is melted by applying heat to each of the holding elements from a side in a direction orthogonal to the stacking direction.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage module comprising:
an electrode body including a plurality of electrodes stacked on each other; and
a frame body that has a shape surrounding a periphery of the electrode body and that holds an edge portion of the electrode body, wherein:
the frame body includes
a pair of outer holding portions that holds outer end portions of the edge portion of the electrode body in a stacking direction of the electrode body, and
an intermediate holding portion that is provided between the outer holding portions in the stacking direction and that holds a portion of the edge portion of the electrode body other than the portions held by the outer holding portions; and
a length of the outer holding portions in an orthogonal direction orthogonal to the stacking direction is greater than a length of the intermediate holding portion in the orthogonal direction.

2. The power storage module according to claim 1, wherein an outer surface of each of the outer holding portions is positioned outside an outer surface of the intermediate holding portion in a direction orthogonal to the stacking direction.

3. The power storage module according to claim 2, wherein the outer surface of the intermediate holding portion has a shape curved so as to be convex toward the electrode body.

4. The power storage module according to claim 1, wherein a length of the portion of the edge portion of the electrode body held by the intermediate holding portion in the orthogonal direction is less than a length of the portions of the edge portion of the electrode body held by the outer holding portions in the orthogonal direction.

5. A method of manufacturing a power storage module including an electrode body including a plurality of electrodes stacked on each other, and a frame body that has a shape surrounding a periphery of the electrode body and that holds an edge portion of the electrode body, the method comprising:
stacking the electrodes and holding elements that hold edge portions of the electrodes via a separator; and
forming the frame body by melting the holding elements and integrating the holding elements, wherein in the stacking, the electrodes and the holding elements are stacked via the separator such that outer surfaces of the holding elements disposed on an outer side in a stacking direction of the electrode body are positioned on an outer side in a direction orthogonal to the stacking direction with respect to an outer surface of the holding element disposed at a center in the stacking direction.

6. The method according to claim 5, wherein in the forming of the frame body, the holding elements are melted by applying heat to the holding elements from a side in the direction orthogonal to the stacking direction.
